(19) United States
(12) Patent Application Publication
(10) Pub. No.: US 2011/0145319 A1
(43) Pub. Date: Jun. 16, 2011

(54) GROUP SESSION MANAGEMENT AND ADMISSION CONTROL OF MULTIPLE INTERNET PROTOCOL FLOWS

(76) Inventors: Michael F. Dolan, Bolingbrook, IL (US); Konstantin Livanos, Naperville, IL (US)

(21) Appl. No.: 12/638,462

(22) Filed: Dec. 15, 2009

(51) Int. Cl. G06F 15/16; G06F 17/00

(52) U.S. Cl. 709/203; 726/1

(57) ABSTRACT

The present invention provides a method for establishing a plurality of flows between an application server and user equipment to support one or more applications. The method includes transmitting a group request from the application server to a policy server. The group request is to establish the flows and includes information indicating one or more relationships between the flows. The method also includes receiving, at the application server and from the policy server, a response to the group request indicating whether the flows have been established subject to one or more constraints imposed by the relationship(s).

### BACKGROUND OF THE INVENTION

1. Field of the Invention

This invention relates generally to communication systems, and, more particularly, to wireless communication systems.

2. Description of the Related Art

Wireless communication systems typically implement numerous access networks to provide wireless connectivity to user equipment, which may also be referred to as mobile units, mobile stations, subscriber stations, subscribers, and the like. The first wireless communication systems focused almost exclusively on providing voice calls to mobile users. However, the functionality of user equipment, the air interface bandwidth on the uplink and downlink supported by the access networks, and the capacity of the wireless networks have increased exponentially and are expected to continue to increase. This growth of the capabilities of the user equipment and the wireless network has enabled service providers to support more sophisticated applications. For example, user equipment often include relatively high-resolution color screens that can receive video data and cameras (or connections for cameras) that can generate and transmit video data over the wireless network. When used in combination with existing voice/audio services, the video capabilities of the network and the user equipment can be used to support video teleconferencing, gaming and other multimedia applications.

Application servers in the wireless communication system can be used to support various applications, including video teleconferencing, gaming and other multimedia applications. Applications can open several Internet protocol (IP) flows that are used to provide a service. For instance, a video conferencing application can request that bearers be opened for a video IP flow and an audio IP flow for each member of the conference. The request may include information indicating a desired and/or required latency, delay, jitter, and/or bandwidth for each flow. The request is typically sent to a policy control and rules function (PCRF), which attempts to allocate the requested resources for each flow based on priorities indicated in each member's user profile that is used by the PCRF. The PCRF then sends a request for the resources for each bearer to the access network(s) that provide connectivity to the members.

Since each IP flow is requested separately by the PCRF, the access network(s) will see separate IP flows that are not coordinated into a session, e.g., the access networks will open and handle the audio IP flow independently of the video IP flow for each user. Thus, an access network may allow the audio IP flows to be established in a congested situation but may not allow the associated video IP flows. However, if the video portion of the conference is considered important, this may contradict a desire to admit users only when they are able to establish both the audio IP flow and the associated video IP flow. Alternatively, the access network may allocate resources to the audio and video IP flows for a subset of the users and deny the audio IP flows for other users. In cases where the video portion of the conference is not considered important, this may contradict a desire to admit audio IP flows prior to any video IP flows to increase the number of users that participate in the conference using at least the audio IP flow.

One conventional approach to addressing this problem is to use priority control mechanisms in the network to adjust priorities associated with the different IP flows to approximate the desired allocation of the resources for the IP flows associated with an application. For example, the wireless communication system typically implements a policy and charging rules function (PCRF) that maintains user profiles indicating priorities associated with each user. The PCRF can adjust the priorities of the various IP flows associated with each user to guide resources towards the higher priority IP flows, while steering resources away from IP flows that are not as critical to the application. However, this approach requires a certain amount of guesswork to set the priorities at values that lead to a resource allocation that approximates the desired resource allocation. If the priorities are not set correctly, the actual allocation of resources to the different IP flows can deviate significantly from the desired allocation. Furthermore, simply adjusting the priorities of the different IP flows does not allow correlation of the IP flows of different users belonging to the same session. Dynamic modification of flow priorities based on application needs is also not possible in the current art. For example, simply adjusting the priorities of different IP flows does not allow the network to determine desired correlations between the audio IP flows and/or the video IP flows for a video conferencing session or a gaming session with multiple participants. Additionally, the video conferencing application would not be able to adjust priority relationships of the IP flows based on feedback from the PCRF.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for establishing a plurality of flows between an application server and user equipment to support one or more applications. The method includes transmitting a group request from the application server to a policy server. The group request is to establish the flows and includes information indicating one or more relationships between the flows. The method also includes receiving, at the application server and from the policy server, a response to the group request indicating whether the flows have been established subject to one or more constraints imposed by the relationship(s).

In another embodiment, a method is provided for establishing flows between an application server and user equipment to support one or more applications. The method includes receiving, from the application server at a policy server, a group request to establish the flows. The group request includes information indicating one or more relationships between the flows. The method also includes determining, at the policy server, whether the flows can be established subject to one or more constraints imposed by the relationship(s). The method also includes transmitting, to the application server and from the policy server, a response to the group request indicating whether the flows have been established.

In a third embodiment, a method is provided for establishing flows between an application server and user equipment to support one or more applications. The method includes receiving, from the application server at a policy server, a group request to establish the flows. The group request includes information indicating one or more relationships between the flows. The method also includes determining, at the policy server, whether the flows can be established subject to one or more constraints imposed by the relationship(s). The method also includes transmitting, to the application server and from the policy server, a response to the group request indicating whether the flows have been established. The method also includes the policy server receiving additional requests from the application server to modify the relationships between the IP flows for an existing group request.

In a fourth embodiment, a method is provided for establishing flows between an application server and user equipment to support one or more applications. The method includes receiving, from the application server at a policy server, a group request to establish the flows. The group request includes information indicating one or more relationships between the flows. The method also includes determining, at the policy server, whether the flows can be established subject to one or more constraints imposed by the relationship(s). The method also includes transmitting, to the application server and from the policy server, a response to the group request indicating whether the flows have been established. The method also includes the policy server attempting allocation of resources for failed bearer(s) or flow(s) in a different access network technology based on the subscriber's profile, group profile and/or negotiation between the application and policy servers.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates information flows in a first exemplary embodiment of a wireless communication system;

FIG. 2 conceptually illustrates a second exemplary embodiment of a wireless communication system; and

FIG. 3 conceptually illustrates one exemplary embodiment of a method for establishing relationships between flows associated with an application.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally speaking, the present application describes techniques and functionality that can be implemented in a communication system to allow applications to specify relationships between data flows in the communication system. The relationships may be specified for data flows between individual users or groups of users. Exemplary embodiments of the control capability described herein allow applications (such as video conferencing, gaming, and the like) to indicate one or more relationships between a number of uplink and/or downlink data flows that jointly create the desired service, and to modify those relationships based on feedback from the policy server. For example, the application can transmit information to a policy server that includes a list of participants, the set of data flows used to provide the service, priorities of the data flows, and the relationships between the data flows. The policy server can then use the information provided by the application to establish flow policies and/or rules and to request resources for the data flows, e.g., from one or more access networks. The set of data flows can span one or more users and multiple technologies, and the users may be served by a single or multiple service providers. Each data flow can be related to other data flows in ways that reflect the precedence of the data flows and the interdependencies of the data flows. Based on information provided by the policy server to the application server, the application server may choose to issue modification requests to the policy server for a previously established group request.

In one exemplary embodiment, an application can use four data flows per user to create a particular service, i.e., flows A, B, C, and D can be used to support the service. The symbol A1 indicates flow A for user 1, B2 indicates flow B for user 2, etc. One exemplary relationship that can be specified by the application is that A1 and A2 should be given top priority and allocated together or not at all. The application may also indicate that flows B1, B2, C1, and C2 are interrelated and should be allocated concurrently. The application may further indicate that flows D1 and D2 are lowest priority and have no inter-dependency on any of the other flows. The policy server can then use the specified relationships to establish the policy rules and request resources. As discussed in detail herein, the relationships may indicate hard rules that must be satisfied and/or relatively soft rules that should be satisfied if possible. Furthermore, the policy server and the application can negotiate the nature of the specified relationships. For example, if the policy server is unable to obtain resources to support a sufficient number of flows that are related by an initial set of relationships, the policy server and the application can negotiate a new set of relationships to attempt to obtain resources for a sufficient number of flows to support the service.

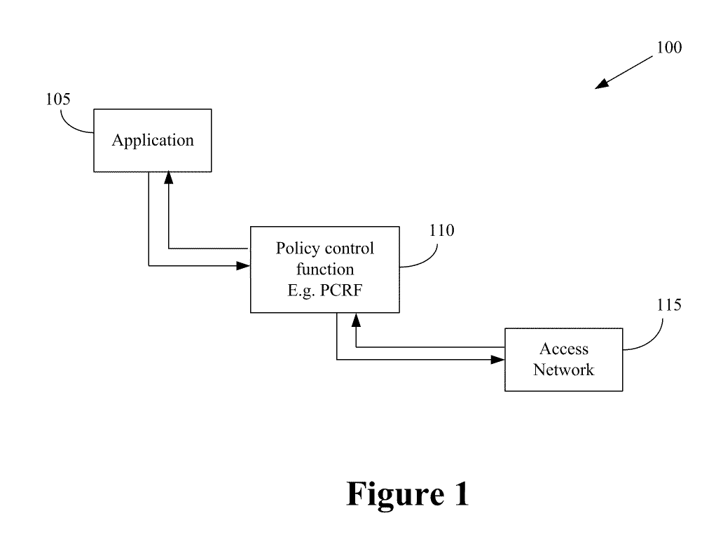

FIG. 1 conceptually illustrates information flows in a first exemplary embodiment of a wireless communication system 100. In the illustrated embodiment, the wireless communication system 100 includes one or more applications 105, one or more policy control and rules functions (PCRF) 110, and one or more access networks 115 that are used to provide wireless connectivity over an air interface. A single application 105, PCRF 110, and access network 115 are depicted in FIG. 1 to clearly illustrate the flow of information within the wireless communication system 100. However, persons of ordinary skill in the art having benefit of the present disclosure should appreciate that alternate embodiments of the wireless communication system 100 may include any number of applications 105, policy servers such as the PCRF 110, and access networks 115. Moreover, persons of ordinary skill in the art should appreciate that other types of devices may be used to provide wireless connectivity in conjunction with or in addition to the access networks 115. Exemplary devices include base stations, base station routers, access points that operate according to IEEE standards and/or protocols, devices that operate according to Bluetooth standards and/or protocols, and the like.

The application 105 initially requests bearers to support the information flows associated with the service. The information flows are intended to provide information to user equipment (which may include one or more devices such as mobile units) and receive information from user equipment in the wireless communication system 100. The requests are provided to the PCRF 110 using messages, data structures, and/or a language defined to carry this information between the application 105 and the PCRF 110. The application 105 also provides information indicating the desired relationships between the requested flows and requests allocation of resources to the flows in a manner that supports and is consistent with the requested relationships. The PCRF 110 can optionally acknowledge receipt of the request. Upon receipt of the request, the PCRF 110 can formulate policies and/or rules that govern operation of the bearers using the information in the bearer request, such as information indicating the number of bearers, the termination points for the requested bearers (e.g., user equipment identifiers, IP address assigned to device and subscription ID), bandwidth, latency, and/or jitter requirements. The formulated policies and/or rules also reflect the relationships between the bearers/flows and any priorities that have been specified in the bearer request.

The PCRF 110 transmits the flow policies and/or rules to the access network 115 with a request to establish bearers according to the provided policies and/or rules. The request may also include identifiers for each of the flows and/or bearers. The access network 115 attempts to establish the requested bearers and/or flows according to the policies that reflect the interdependencies of the bearers and/or flows and priorities associated with the bearers and/or flows. For example, the access network 115 can attempt to establish the requested bearers and/or flows by allocating available resources according to the specified policies and/or priorities. The access network 115 can then return a message indicating which bearers and/or flows have been successfully established and which bearers and/or flows were not successfully established. The PCRF 110 then informs the application 105 of the success and/or failure of the attempt to establish the requested bearers and/or flows. The application 105 and the PCRF 110 may in some cases negotiate the requested resources, relationships, priorities, or other parameters based on the success and/or failure of the attempt to establish the requested bearers and/or flows, as discussed herein.

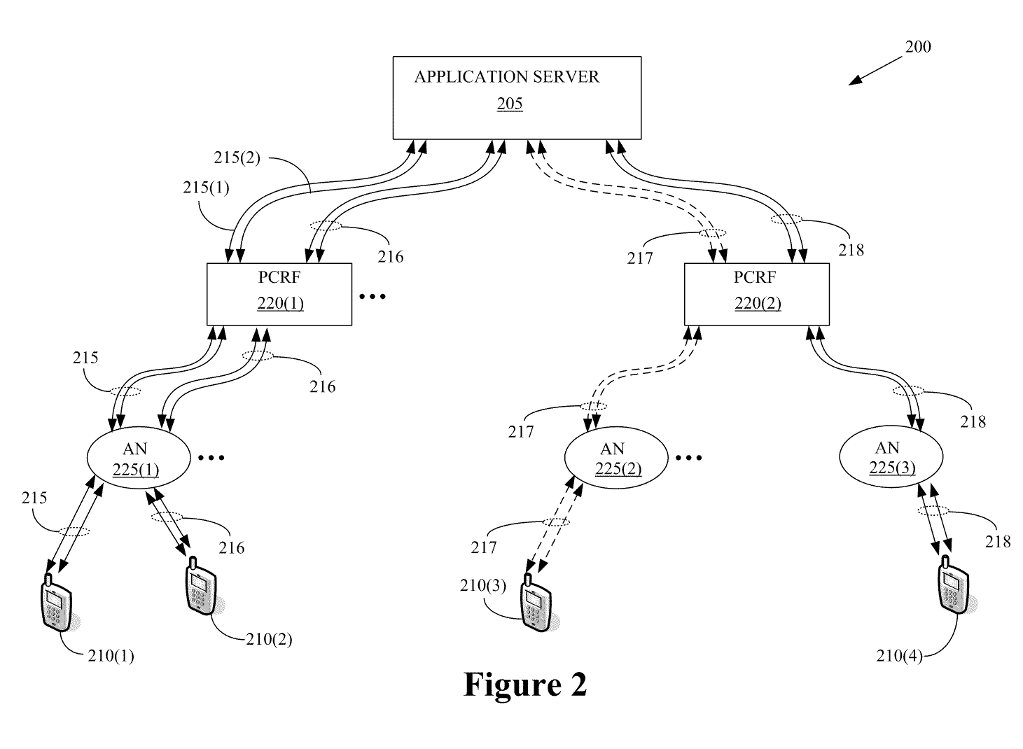

FIG. 2 conceptually illustrates a second exemplary embodiment of a wireless communication system 200. In the illustrated embodiment, an application server 205 is used to provide one or more applications to user equipment 210 using interrelated flows 215, 216, 217, 218. For example, the flow 215(1) can be used to carry an audio Internet Protocol (IP) flow that is used for conferencing, gaming, or other communication applications. The flow 215(2) can be used to carry a video IP flow for the same application. The flows 215(1-2) are interrelated and the application server 205 can specify relationships between the flows 215 and request that these relationships be maintained when resources are allocated for the flows 215. The pairs of flows 216, 217, 218 may also represent pairs of interrelated flows such as audio IP flows and video IP flows. Moreover, the flows 215, 216, 217, 218 may support uplink and/or downlink flows of information depending on the particular application provided by the application server 205.

The application server 205 specifies the relationships between the flows 215, 216, 217, 218 when the application server 205 requests establishment of the bearers and/or flows 215, 216, 217, 218. For example, if the application server 205 is attempting to establish a video conference between users of the user equipment 210, the application server 205 can transmit a request to the PCRF servers 220 that indicates the requested flows 215, 216, 217, 218 as well as the interrelationships between these flows. One possible set of interrelationships between these flows states that the pairs of flows 215, 216, 217, 218 can be established independently but that the individual flows within each of the pairs of flows 215, 216, 217, 218 must be established together. Alternatively, if one of the individual flows within each of the pairs of flows 215, 216, 217, 218 is considered more important, another possible set of interrelationships between these flows could request that as many of the flows 215, 216, 217, 218 as possible be established but that only the preferred one of the pairs of the flows 215, 216, 217, 218 must be established. For example, the specified interrelationships may request that the audio IP flow 215(1) in each of the pairs of flows 215, 216, 217, 218 be preferentially established.

The relationships between the flows may also reflect priorities associated with the user equipment 210. For example, user equipment 210(1) may be the moderator for the videoconference and may be given a higher priority. The application server 205 can specify a relationship that reflects this priority, e.g., the application server 205 may specify a relationship between the flows associated with the user equipment 210 that states that the flows 215 to the moderator user equipment 210(1) are to be allocated before the videoconference can be initiated. The application server 205 may also specify that both the audio IP flow 215(1) and the video IP flow 215(2) are to be established in order for the videoconference to take place. Alternatively, the application server 205 can specify that only one of the flows, such as the audio IP flow 215(1), be established before the videoconference can be initiated. In some embodiments, the application server 205 can also specify interrelationships between groups of user equipment. For example, the application server 205 may specify a relationship that at least one flow 215, 216, 217, 218 is to be established to each of the user equipment 210 before the videoconference can be initiated. For another example, the application server 205 may specify that flows are to be established to at least a minimum number of user equipment 210 before the videoconference can be initiated.

The PCRF servers 220 establish policies and/or rules for the requested flows 215, 216, 217, 218 based on the information received from the application server 205. The established policies and/or rules can be transmitted to the various access networks 225, which attempt to allocate resources subject to the constraints imposed by the policies and/or rules conveyed by the PCRF servers 220. In the illustrated embodiment, the access networks 225 are able to allocate resources to support the requested flows 215, 216, 218 but are not able to allocate resources to support the requested flows 217 (as indicated by the dashed lines). The access networks 225(1, 3) therefore transmit acknowledgments to the PCRF servers 220 indicating the successful allocation of resources for flows 215, 216, 218. The access network 225(2) may also transmit a negative acknowledgment to the PCRF server 220(2) indicating that resources were not successfully allocated to the requested flow 217. Persons of ordinary skill in the art having benefit of the present disclosure should appreciate that the PCRF servers 220 and/or the access network 225 may operate according to the same or different standards, protocols, and/or access technologies.

The PCRF servers 220 convey the substance of the acknowledgments to the application server 205 so that the application server 205 can decide how to proceed. In one embodiment, the application server 205 determines that a sufficient number of the requested bearers and/or flows have been allocated and initiates the application. The request for the flow 217 may then be dropped, queued, and/or periodically resubmitted. Alternatively, the application server 205 can determine that one or more of the flows 217 should be allocated before initiating the application. The application server 205 may then revise or modify the bearer and/or flow request. For example, the application server 205 may request a lower bandwidth or weaker delay and/or jitter constraints. For another example, the application server 205 may modify a previous relationship that requested that the flows 217 be allocated together and send a new relationship requesting that at least one of the flows 217 be allocated. The application server 205 and the PCRF servers 220 may iteratively repeat this negotiation process until the application server 205 determines that a sufficient number of user equipment 210 has been admitted or until a termination criterion has been reached.

The relationships between the flows 215, 216, 217, 218 can also be dynamically modified. For example, once the requested flows 215, 216, 218 have been established, the application server 205 can begin providing the application to the user equipment 210. The various entities in the wireless communication system 200 may then monitor operating conditions and/or parameters while the application is being provided using the existing flows 215, 216, 218. Changes within the wireless communication system 200 may lead to modifications in the relationships specified by the application server 205. For example, changes in environmental conditions and/or channel conditions associated with the air interfaces supported by the access networks 225 may allow the access networks 225 to allocate more or fewer resources, which may allow the access networks 225 to support more or fewer flows. This information can be conveyed to the application server 205, which may use the information to decide whether to modify the specified relationships, e.g., by requesting more stringent relationships when more resources are available or less stringent relationships when fewer resources are available. For another example, additional user equipment may request admission to the services provided by the application server 205 or other user equipment having existing flows may drop the services. The relationships may be modified in response to the addition or subtraction of user equipment, e.g., by requesting more stringent relationships when fewer user equipment would like to use the application or less stringent relationships when more user equipment would like to use the application.

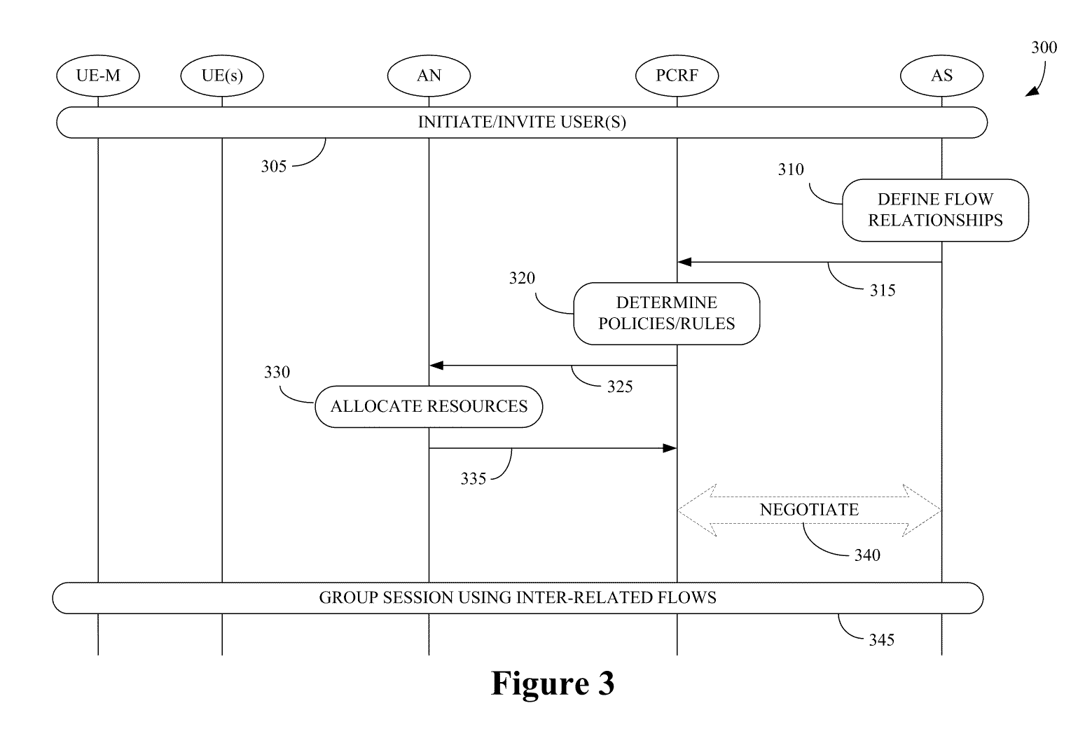

FIG. 3 conceptually illustrates one exemplary embodiment of a method 300 for establishing relationships between flows associated with an application. In the illustrated embodiment, a user initiates (at 305) a group session for service with multiple users that are each served by multiple flows, such as audio and/or video IP flows or other IP data flows. The initiating user is a moderator for the group and operates user equipment designated as UE-M. One or more other users in the group operate user equipment designated as UE. Although the moderator initiates the group session in the exemplary embodiment of the method 300, persons of ordinary skill in the art having benefit of the present disclosure should appreciate that any entity having access to the wireless communication system could alternatively initiate the group session or other session including one or more user equipment. Initiation (at 305) of the group session may include defining and/or providing an identifier, such as a Group_ID, for the group session.

In response to the group session being initiated, an application server (AS) that provides the services or applications for the group session retrieves data associated with the group session, e.g., from a memory or other storage device in the application server or from a device that is implemented elsewhere. The application server then invites (at 305) the users to the group session, e.g., by providing a Session Initiation Protocol (SIP) invitation message to the user equipment. The invitation message can be delivered to the user equipment via one or more access networks (AN) and any other intervening or supporting networks in the system. In various alternative embodiments, the participants may be attached and/or connected to networks spanning multiple access technologies, networks, and/or service providers. The user equipment and the application server may then define, determine, negotiate, and agree to the parameters that are used to initially define the session.

The application server uses the negotiated session parameters to determine (at 310) one or more relationships between the flows provided by the application. The relationships are used to define an authorization request message, such as a Group Quality of Service Authorization Request message. In one embodiment, the Group QoS Authorization Request message includes a list of the users participating in the group session, a list of the data flows associated with each of the users participating in the group session, the determined relationships between the data flows and/or the users, and priorities associated with the data flows and/or the users. Persons of ordinary skill in the art having benefit of the present disclosure should appreciate that alternative embodiments of the authorization request message may include additional information. The authorization request message is then transmitted (at 315) to one or more policy servers such as PCRF servers.

The policy server(s) extract information from the authorization request message and use this information to determine (at 320) policies and/or rules for establishing the requested bearers and/or flows subject to the constraints imposed by the flow relationships and the priorities associated with the bearers and/or flows. For example, each PCRF can process the Group-Auth-Request, determine the appropriate policies/rules, and authorize or request resources for the group session. Each PCRF also can assign an identifier, such as a Group Correlation-ID (GC-ID), to the group session. The PCRF then sends (at 325) a message requesting that resources be allocated to the participants of the group session. The message also indicates that the resources should be allocated subject to the policies and/or rules that reflect the flow relationships transmitted by the application server. For example, the PCRF can send a Connection-Set-Up message to each access network that provides wireless connectivity to one or more of the users that are receiving the service or application. The message triggers the allocation of resources and the establishment of dedicated bearers for each flow associated with each user.

The access network(s) attempt to allocate (at 330) the requested resources and establish the dedicated bearers. In one embodiment, a network entity in the access network that is responsible for admission control, such as an eNB in LTE, receives the request to admit a group session, along with the GC-ID, and processes the request. The entity can then allocate (at 330) available resources to the requested bearers and/or flows. If resources are not available to admit all the requested flows in the group session then the admission control entity may queue for the appropriate resources for the remaining flows. If sufficient resources for all the requested flows become available, then the access network can allocate (at 330) resources to the requested bearers and/or flows. However, resources may only be allocated (at 330) to a subset of the requested bearers and/or flows if sufficient resources do not become available, e.g. within a pre-determined time interval. For example, the limited pool of resources may be allocated (at 330) to a subset of the requested bearers and/or flows based on the priorities of the bearers and/or flows such that the highest priority flows are allocated (at 330) resources first.

In some embodiments, the wireless communication system may include access networks that support multiple radio access technologies. The access network(s) attempt to allocate (at 330) the requested resources and establish the dedicated bearers using an initial radio access technology, which may be specified in the subscriber's profile, group profile and/or by negotiation between the application and policy servers. If resources are not available to admit all the requested flows using the initially requested access network technology, the admission control entity may attempt to allocate (at 330) resources using a different access network technology. For example, a policy server may attempt to allocate (at 330) resources for failed bearer(s) or flow(s) in a different access network technology based on the subscriber's profile, group profile and/or negotiation between the application and policy servers.

Once the allocation process is complete, the access network returns (at 335) a message indicating whether the resources were successfully allocated and which bearers and/or flows received the allocated resources. The method may also include information indicating the access network technology that was used to establish the bearers and/or flows.

The PCRF processes (at 340) the responses it receives from the access networks and notifies the application server of the results of the attempt to allocate resources to the requested bearers and/or flows. The application server can initiate the requested session when it determines that a sufficient number of the flows and/or users have been admitted. For example, the application server may only initiate the requested session if all the participants have been allocated resources for at least some of the requested flows. Alternatively, the application server may initiate the requested session when the moderator and at least a selected number of users have been admitted.

The application server may also negotiate (at 345) with the PCRF when less than all of the requested bearers and/or flows have been admitted subject to the constraints imposed by the initially determined service relationship(s). For example, the PCRF can identify the users and/or the flows that were not admitted. The application server processes the response from the PCRF(s) and, in case of failure to admit all the users and flows, the application server determines whether a sufficient number of users and flows high priority flows have been admitted in order have a viable group session. If an insufficient number have been admitted, then the application server can modify the request (e.g., by modifying the requested resources and/or the flow interrelationships) and send the modified request back to the PCRF, which may then attempt to obtain the requested resource allocation from the access networks. This process can proceed iteratively.

Once resources have been allocated to at least a subset of the requested bearers and/or flows, the application server can initiate (at 345) the group session using the interrelated flows. As discussed herein, the elements in the communication system can continue to monitor various system parameters and/or conditions so that the flow relationships and/or requested resources can be modified in response to any changes in the state of the communication system. This monitoring may occur concurrently with providing (at 345) the group session using the interrelated flows.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for establishing a plurality of flows between an application server and user equipment to support at least one application, comprising:
transmitting, from the application server to a policy server, a group request to establish the plurality of flows, the group request including information indicating at least one relationship between at least two of the plurality of flows; and
receiving, at the application server and from the policy server, a response to the group request indicating whether the plurality of flows have been established subject to at least one constraint imposed by said at least one relationship.

2. The method of claim 1, comprising determining said at least one relationship between said at least two of the plurality of flows based on session parameters for the plurality of flows, the session parameters being negotiated between the application server and the user equipment.

3. The method of claim 2, comprising transmitting, from the application server to the user equipment, an invitation to join said at least one application and negotiating the session parameters for the plurality of flows based on responses received from the user equipment at the application server.

4. The method of claim 1, wherein transmitting the group request comprises transmitting a group request indicating a plurality of priorities assigned to a plurality of user equipment.

5. The method of claim 1, wherein receiving the response to the group request comprises receiving a response indicating that the plurality of flows have been established as requested and initiating said at least one application using the established plurality of flows.

6. The method of claim 1, wherein receiving the response to the group request comprises receiving a response indicating that less than all of the plurality of flows have been established as requested.

7. The method of claim 6, comprising determining, at the application server, whether a sufficient number of the plurality of flows has been established based on the response to the group request.

8. The method of claim 7, comprising initiating an application using the established flows if the application server determines that a sufficient number of the plurality of flows has been established.

9. The method of claim 7, comprising iteratively modifying the group request in response to determining that an insufficient number of the plurality of flows has been established, transmitting the modified group request from the application server to the policy server, and determining whether a sufficient number of the plurality of flows has been established based on a response to the modified group request.

10. The method of claim 9, wherein iteratively modifying the group request comprises modifying the group request to allow flows to be established using an alternative access network technology.

11. The method of claim 9, comprising initiating an application using the established flows when a sufficient number of the plurality of flows has been established or terminating the application if the application server determines that a sufficient number of the plurality of flows cannot be established based on a predetermined criterion.

12. The method of claim 1, comprising grouping a subset of the plurality of user equipment into a plurality of groups, each group comprising more than one user equipment.

13. The method of claim 12, wherein transmitting the group request comprises transmitting a group request including information indicating at least one relationship between at least two of the plurality of groups, and wherein receiving the response to the group request comprises receiving a response indicating whether the plurality of flows have been established subject to at least one constraint imposed by said at least one relationship between said at least two of the plurality of groups.

14. The method of claim 1, comprising receiving, from the policy server to the application server, at least one message requesting an updated group request, said at least one message being transmitted subsequent to establishing at least one of the flows.

15. The method of claim 14, comprising generating the updated group request in response to receiving said at least one message and transmitting the updated group request from the application server to the policy server.

16. The method of claim 1, wherein said at least one application comprises at least one videoconferencing application, and wherein the plurality of flows include at least one audio Internet Protocol (IP) flow and at least one video IP flow for each user equipment, and wherein transmitting the group request indicating said at least one relationship between at least two of the plurality of flows comprises transmitting a group request indicating a plurality of relationships between the audio IP flow and the video IP flow for each user equipment.

17. A method for establishing a plurality of flows between an application server and user equipment to support at least one application, comprising:
receiving, from the application server at a policy server, a group request to establish the plurality of flows, the group request including information indicating at least one relationship between at least two of the plurality of flows;
determining, at the policy server, whether the plurality of flows can be established subject to at least one constraint imposed by said at least one relationship; and
transmitting, to the application server and from the policy server, a response to the group request indicating whether the plurality of flows have been established.

18. The method of claim 17, wherein determining whether the plurality of flows can be established comprises:
generating at least one request for resources for the plurality of flows subject to said at least one constraint;
transmitting said at least one request to at least one access network that provides wireless connectivity to the plurality of user equipment; and
receiving at least one response from said at least one access network indicating whether the requested resources have been allocated by said at least one access network.

19. The method of claim 17, wherein transmitting the response to the group request comprises transmitting a response indicating that less than all of the plurality of flows have been established as requested in response to receiving at least one response from said at least one access network indicating that less than all of the requested resources have been allocated.

20. The method of claim 19, comprising iteratively receiving, at the policy server, a modified group request in response to the application server determining that an insufficient number of the plurality of flows has been established, requesting resources from said at least one access network based on the modified group request, and transmitting a message to the application server indicating whether the plurality of flows has been established based on the modified group request.

21. The method of claim 20, wherein iteratively receiving the modified group request comprises receiving a group request allowing flows to be established using an alternative access network technology.

22. The method of claim 17, comprising transmitting, from the policy server to the application server, at least one message requesting an updated group request, said at least one message being transmitted subsequent to establishing at least one of the flows.

23. The method of claim 22, wherein transmitting said at least one message comprises transmitting said at least one message in response to at least one of a change in at least one condition of at least one channel used to support the plurality of flows, a request to initiate at least one new flow, a request to terminate at least one established flow, a request to reconfigure at least one flow, a request to reconfigure said at least one application, and at least one change in the resources available for supporting flows.

24. The method of claim 23, comprising receiving the updated group request from the application server in response to transmitting said at least one message and requesting resources from said at least one access network based on the updated group request.

25. The method of claim 17, wherein said at least one application comprises at least one videoconferencing application, and wherein the plurality of flows include at least one audio Internet Protocol (IP) flow and at least one video IP flow for each user equipment, and wherein transmitting the group request indicating said at least one relationship between at least two of the plurality of flows comprises transmitting a group request indicating a plurality of relationships between the audio IP flow and the video IP flow for each user equipment.
